(19) United States
(12) Patent Application Publication
(10) Pub. No.: US 2010/0077751 A1
(43) Pub. Date: Apr. 1, 2010

(54) MOVABLE SUPPORT SYSTEM FOR AN ENERGY RECOVERY DEVICE

(76) Inventors: Stéphane Vogel, Le Vesinet (FR); Claude Antonioni, Saint Maurice (FR); Claudio Cavaciuti, Le Blanc Mesnil (FR)

Correspondence Address: NIXON & VANDERHYE, PC, 901 NORTH GLEBE ROAD, 11TH FLOOR, ARLINGTON, VA, 22203, US

(21) Appl. No.: 12/449,526

(22) PCT Filed: Feb. 11, 2008
(86) PCT No.: PCT/FR2008/050205

§ 371 Date: Oct. 29, 2009

(30) Foreign Application Priority Data
Feb. 13, 2007 (FR) 0753230

(51) Int. Cl. F03G 6/00; F03D 9/00; F24J 2/52

(52) U.S. Cl. 60/641.8; 416/170 R; 290/54; 126/623

(57) ABSTRACT

The present invention relates to a movable support system comprising a fixed part, intended to be fixed for example to the frame of a roof, and a moving part that opens completely downwards and towards the interior of the building, and able to be completely removed towards the interior of the building so as to make it easier to fit it or replace it should this be necessary, serving for various energy recovery devices such as a wind turbine, a solar water heater or a photovoltaic solar cell, making it possible, by an assembly means, to fit and maintain it via the interior of the building, and to a concept for a wind turbine, solar water heater or photovoltaic solar cell which is fitted to this support system.

The present invention relates to a mobile support system for energy recovery devices. The invention relates in particular to a mobile support system comprising a fixed frame, intended to be integrated into a building façade (for example a roof), and a mobile panel opening towards the inside of the building and capable of being removed completely towards the inside of the building so as to make it easier to fit it or replace it if needed. The invention is applicable to any energy recovery device, such as a wind turbine, a solar water heater or a photovoltaic solar cell, for example, using assembly means to fit and maintain it via the interior of the building. The invention also relates to a concept for wind turbine, solar water heater and photovoltaic solar cell adapted to this support system.

It is known to use fixed and non-removable support systems for installing a wind turbine, a solar water heater or a photovoltaic solar cell. However, fitting these from the outside on a roof and the maintenance operations are difficult to carry out since it is arduous, dangerous and costly to undertake on a sloping roof. The installation and maintenance costs put a stop to using these products en masse. Also, wind turbines are not well adapted for roofs as they are generally high and imposing for as much collective as individual usage, and do not integrate aesthetically into the landscape.

Japanese patent No. JP 59217379A proposes a support system allowing only partial opening to the inside, due to a central pivoting axis. Also, the system proposed does not resolve the problems of airtightness and watertightness, which are fundamental for being set onto a façade.

Patents U.S. Pat. No. 4,289,120 and U.S. Pat. No. 4,150,660 propose a fixed system without mobile panel. Upkeep or repairs to this device thus require dismantling via the inside of the building by removing the fixing cleats. This takes a very long time to access system, and considerable risk of falling during dismantling. Also, the systems described are not adapted to bulky energy recovery devices.

Therefore, processes of the prior art do not allow easy fitting in a façade (for example a roof) and airtightness and watertightness are very difficult to achieve. Also, according to the type of roof cladding (for example tile, slate), airtightness and watertightness cannot be guaranteed, which engender the infiltration of water and air inside the building and make it impossible to integrate into an existing roof equipped with its own original cladding. They also cannot integrate fitting a larger solar receptor and especially not a wind turbine. Neither do they easily allow necessary upkeep or repairs, since each process comprises flaws and risks for these measures.

The particular aim of the present invention is to avoid these disadvantages and bring a simple, efficacious and economical solution to the problem of integrating different energy recovery systems into a building, either new or existing, in particular a roof.

It proposes to this effect a mobile support system for an energy recovery device, characterised in that it comprises a fixed frame (24), intended to be integrated in a building façade, and a mobile panel (23) supporting on its upper (outer) face the energy recovery device, this mobile panel (23) opening from top to bottom and towards the inside of the building by pivoting on an axis supported on the fixed frame (24) so as to allow full access to the energy recovery device via the inside of the building.

By way of advantage, the axis is supported on the lower part of the fixed frame (24) to allow total opening by pivoting from top to bottom of the mobile panel. In a particular mode, the mobile panel (23) pivots on an axis supported on the transversal bar (24B) of the fixed frame (24).

An essential advantage of the support according to the invention is that it easily allows an operator to access the energy recovery device to carry out installation or maintenance operations via the inside of the building.

Another aspect of the invention relates to an installation process of an energy recovery device on a building, the process comprising integration of the device in a support system comprising a fixed frame fixed on the façade (for example a roof) and a mobile panel opening completely from top to bottom and towards the inside of the building, so as to allow full access to the energy recovery device via the inside of the building. The mobile panel can be removable completely towards the inside of the building to make it easier to replace it, if needed.

The system of the invention is adapted to placing an energy recovery device on any building façade, and especially on the roof, whether a terrace roof or inclined.

According to a preferred embodiment, the mobile panel comprises rims which protrude upwards on at least three sides, these three sides being elevated in the case of a sloping roof, and/or receives sealing hoisted on these three sides to form protection against rainwater.

The mobile panel is preferably kept in a fixed frame fixed to the façade and it pivots down supported on this fixed frame.

When the façade is an inclined roof, the fixed frame contains in its low part a bar arranged transversally relative to the slope, the low part of the lateral rims of the mobile frame having lower notches forming a clearance allowing the mobile panel to be supported on this transversal bar forming a pivot axis and, preferably, angles on the top cut or rounded to allow clearance with the low roof connector.

By way of advantage, roof connectors on the one hand cover the fixed frame and the rims of the mobile panel and, on the other hand, glide in part under the cladding of the roof to form protection of the rims of the mobile panel and of the fixed frame against rainwater.

A supple seal can be arranged between the upper parts of the rims and the lower faces of the roof connectors.

By way of advantage, an holding means of compass or cable type is fixed on the one hand to the fixed frame and on the other hand to the mobile panel, keeping the mobile panel in a predefined position after opening.

According to an embodiment, the mobile panel is locked in the fixed frame in closed position by any adapted means (for example a latch) connected on the one hand to the mobile panel, and on the other hand to the fixed frame.

A supple gasket can be placed between the fixed frame and the rims of the mobile panel.

The mobile panel can comprise two spaced plates, thermal insulation being placed between these plates to prevent a thermal bridge.

According to a characteristic of the invention, the mobile panel has on its upper (external) face a support receiving the energy recovery device.

According to a first particular embodiment of the invention, the support receives a wind turbine. In this case, the mobile panel or the fixed frame typically comprises a passage for a connecting cable of the wind turbine.

The support can have feet which adapt to the slope of the roof, comprising hinges for example.

The support can comprise fixtures for keeping bearings on the one hand supporting the axis of the rotor of the wind turbine, and on the other hand the axis of a generator.

The rotor of the wind turbine can comprise in its low part a wheel with internal teeth, arranged perpendicularly to the axis of rotation, a toothed pinion fixed on the axis of the generator meshing with this wheel.

According to another particular embodiment of the invention, the support receives a photovoltaic solar cell. In this case, the mobile panel or the fixed frame generally includes a passage for a connecting cable of these solar cells.

The connecting cable can comprise a rapid connector located inside the building, in the vicinity of the fixed frame.

According to another embodiment particular of the invention, the support receives circulation tubes for liquid or heat accumulator gas, for example water, heated by solar radiation.

The tubes can be posed by means of supple pieces on supports comprising platens arranged transversally on the mobile panel, the ends of the tubes located on the same side being connected to a feeder fixed on the upper part of the mobile panel.

The feeder can be connected inside the building and in the vicinity of the fixed frame by connectors comprising stopcocks.

The invention likewise relates to novel variants of wind turbines, solar water heater and photovoltaic solar cell, as well as their use, especially in a mobile support such as described hereinabove. In particular, the invention describes a wind turbine comprising a set of curved blades extending vertically from the top to the base of a turret, in multiple directions, and comprising an energy accumulator device (e.g., generator or alternator). The wind turbine is preferably mounted on a toothed wheel whereof the axis of rotation is out of alignment relative to that of the accumulator device. More preferably still, the accumulator device is driven by a toothed wheel of a diameter less than that of the toothed wheel bearing the turret, resulting in a multiplication effect. The blades of the wind turbine are typically made of metal. The dimensions of the wind turbine can be adapted by the person skilled in the art according to its destination (for example collective or individual use), and vary for example between 50-150 cm in diameter approximately, for a height of around 50-150 cm. It is understood that wind turbines of greater or lesser size can be made, according to the use. The wind turbine preferably comprises a set of curved blades, each having a face of dark colour and another face of light colour, producing a hot and cold air current differential to improve energetic performance.

The invention likewise relates to a solar water heater, characterised in that it comprises a turbine connected to an electric generator actuated by the water vapour produced by the water circulation tubes (43), or accumulator liquid, or accumulator gas heated by solar radiation to produce energy. The invention also relates to a solar water heater characterised in that it comprises a heat exchanger or pump for producing cold or heat to create air-conditioning.

The invention will be better comprehended and other characteristics and advantages will emerge more clearly from the following detailed description given hereinbelow by way of example and in reference to the attached diagrams, in which:

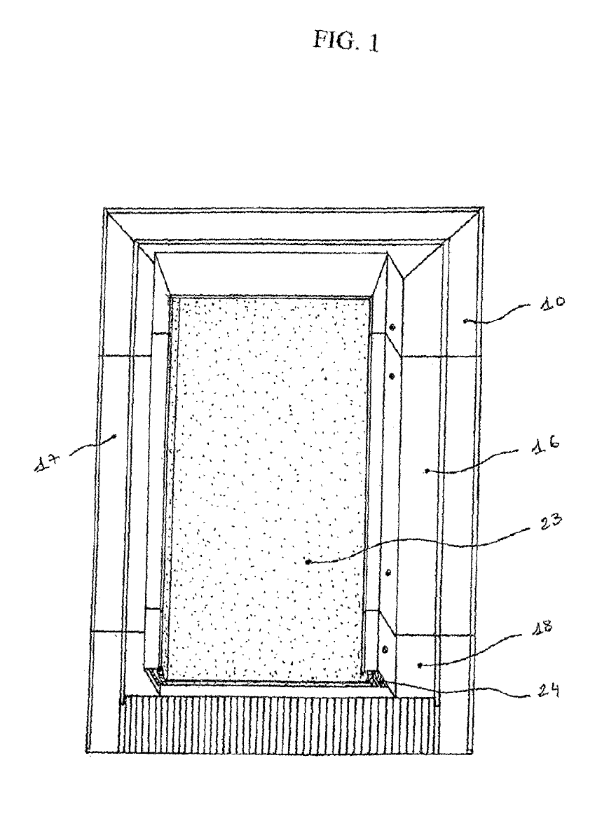

FIG. 1 is an overall perspective view of the roof support system comprising the roof connectors;

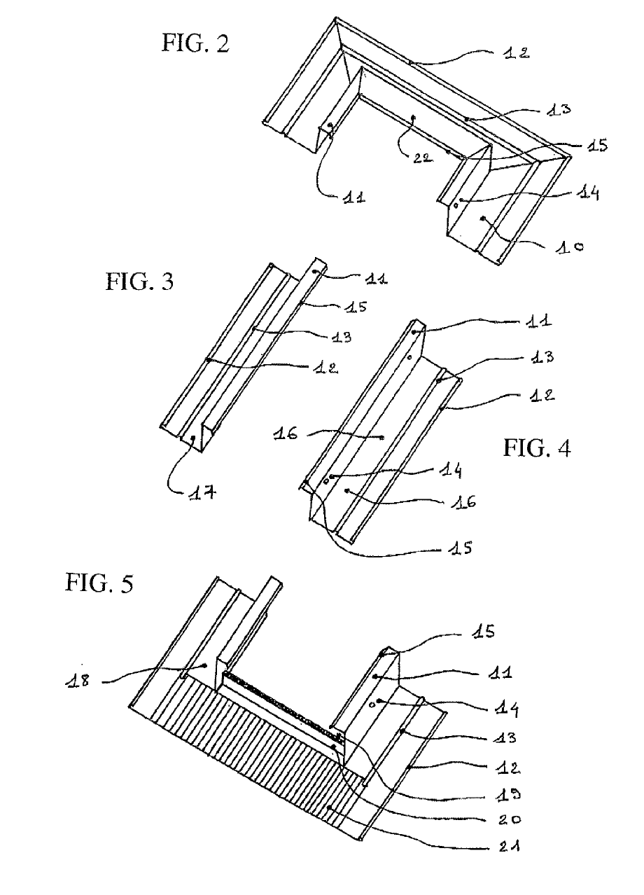

FIG. 2 is a detailed view of the upper part of the roof connectors;

FIG. 3 is a detailed view of the left lateral part of the roof connectors;

FIG. 4 is a detailed view of the right lateral part of the roof connectors;

FIG. 5 is a detailed view of the low part of the roof connectors;

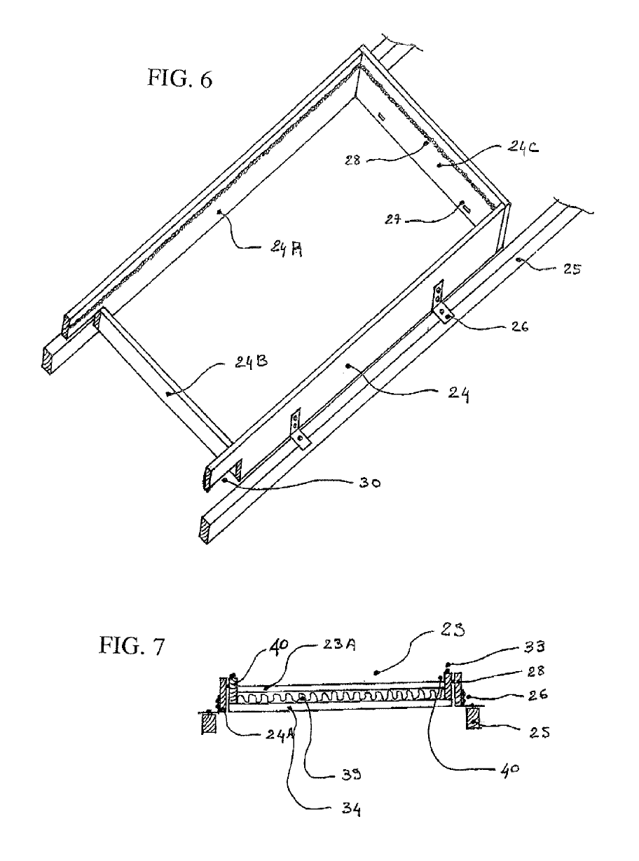

FIG. 6 is a detailed view of the frame comprising fixing on the façade (for example a roof) by metallic angle mounts;

FIG. 7 is a sectional view in the direction of its width of the mobile panel with rims and of the fixed frame;

FIG. 8 is a detailed plan view from above of the mobile panel with rims;

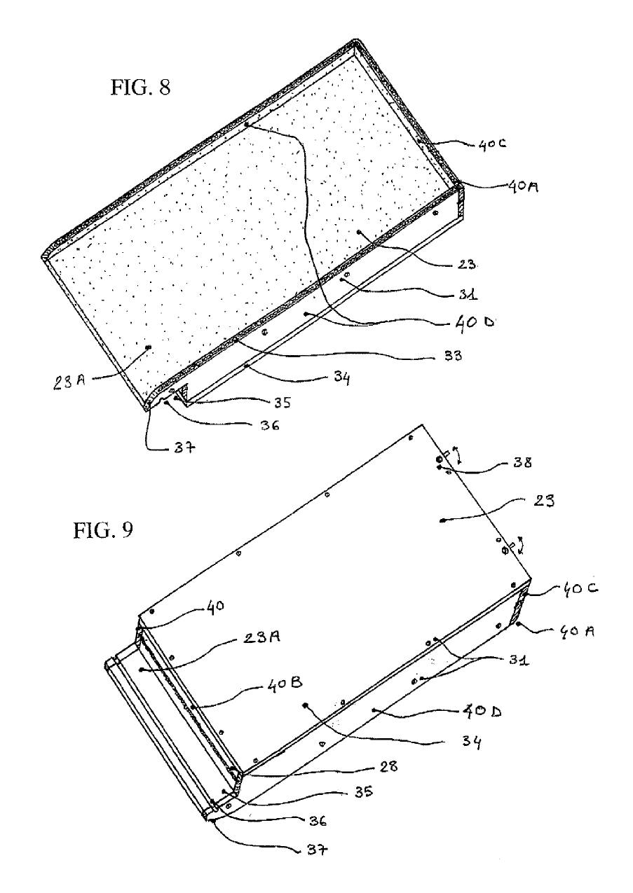

FIG. 9 is a detailed view from below of the mobile panel with rims;

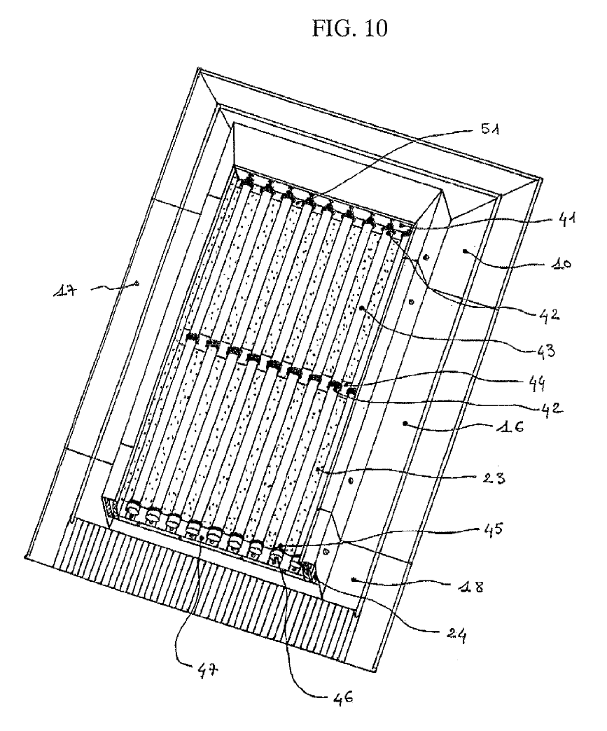

FIG. 10 is an overall perspective view of the roof support system comprising a solar water heater;

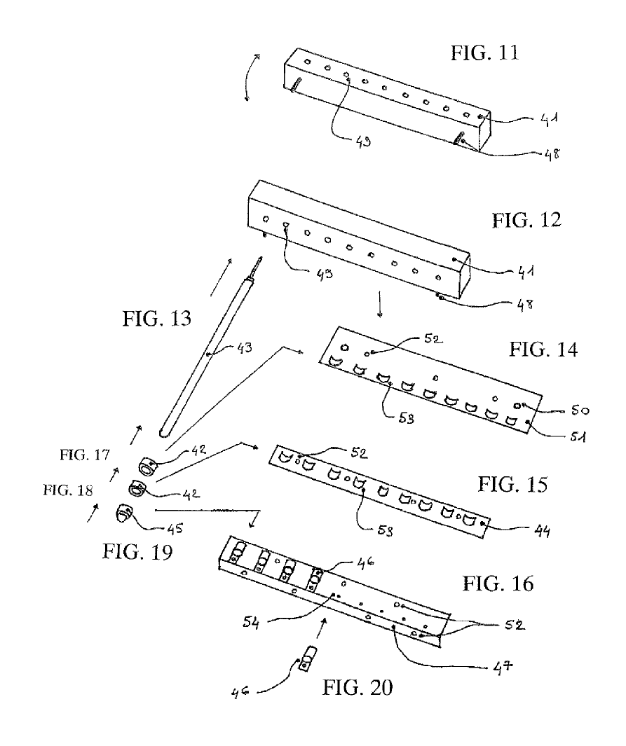

FIGS. 11 to 20 are detailed views of elements making up the solar water heater;

FIG. 21 is an overall perspective view of the roof support system comprising a wind turbine;

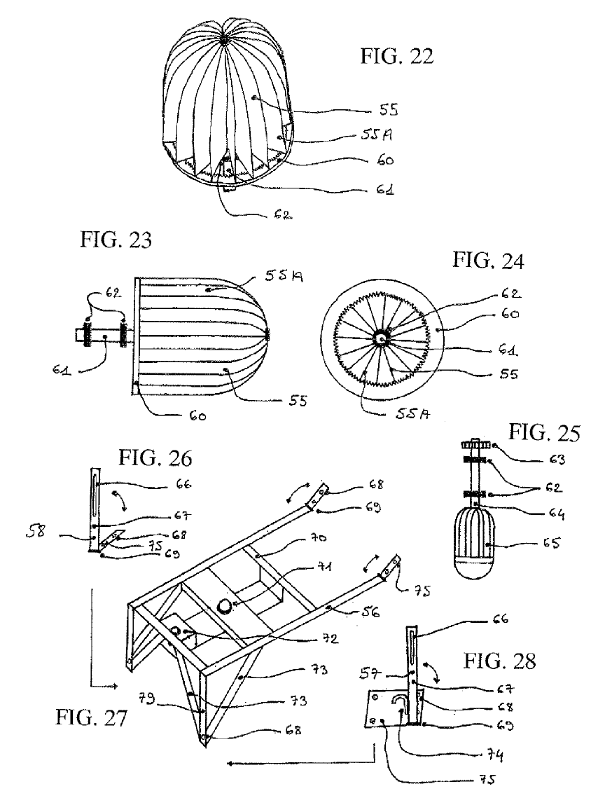

FIGS. 22 to 28 are detailed views of elements making up the wind turbine;

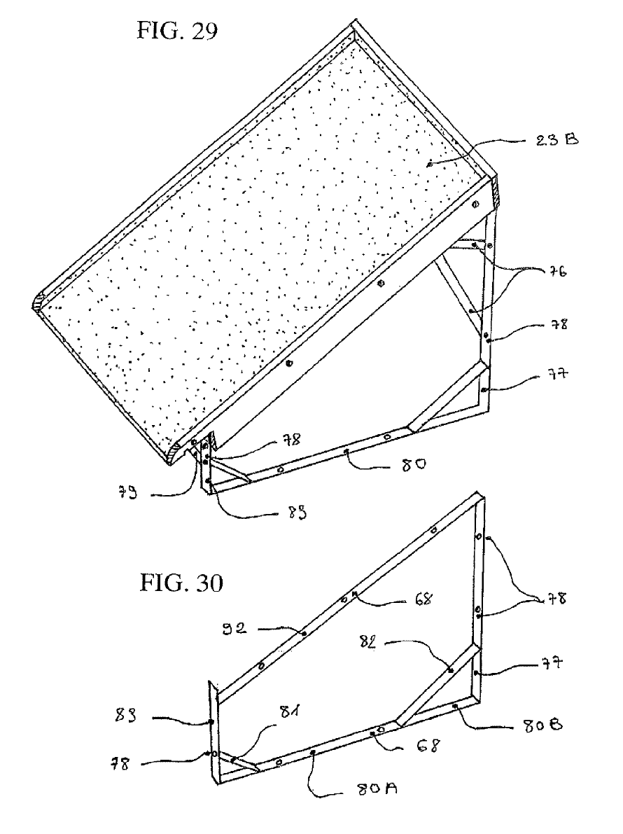

FIG. 29 is an overall view of an inclined support frame of the panel with rims, for placing in a terrace roof or plate;

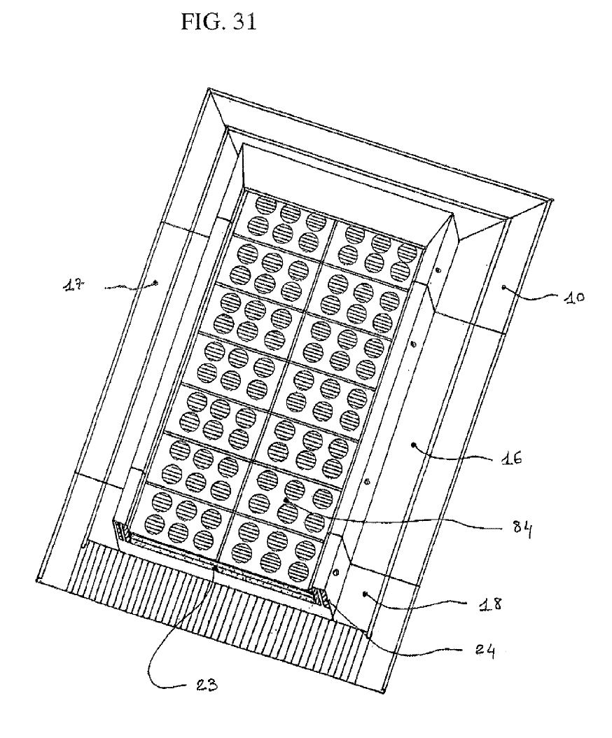

FIG. 30 is a detailed view of a side element of the support frame;

FIG. 31 is an overall perspective view of the roof support system comprising a photovoltaic solar cell;

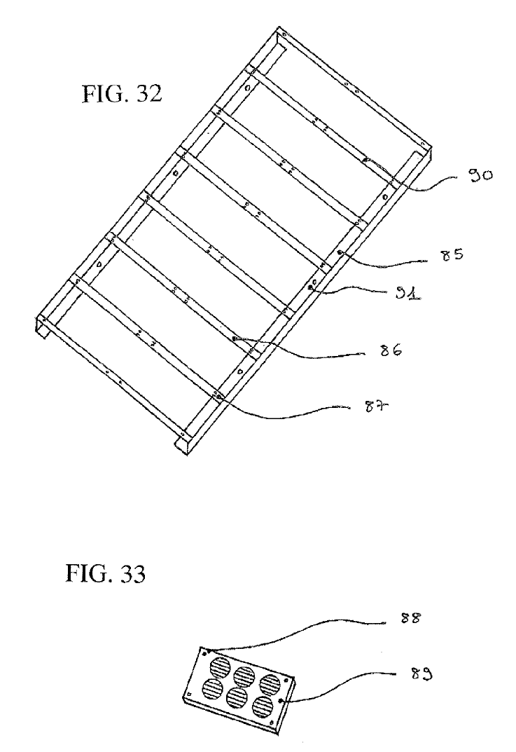

FIG. 32 is a detailed view of a support frame receiving the solar photovoltaic elements;

FIG. 33 is a detailed view of a solar photovoltaic element;

FIG. 34 is a detailed view of a channel section covering the top of the panel with rims;

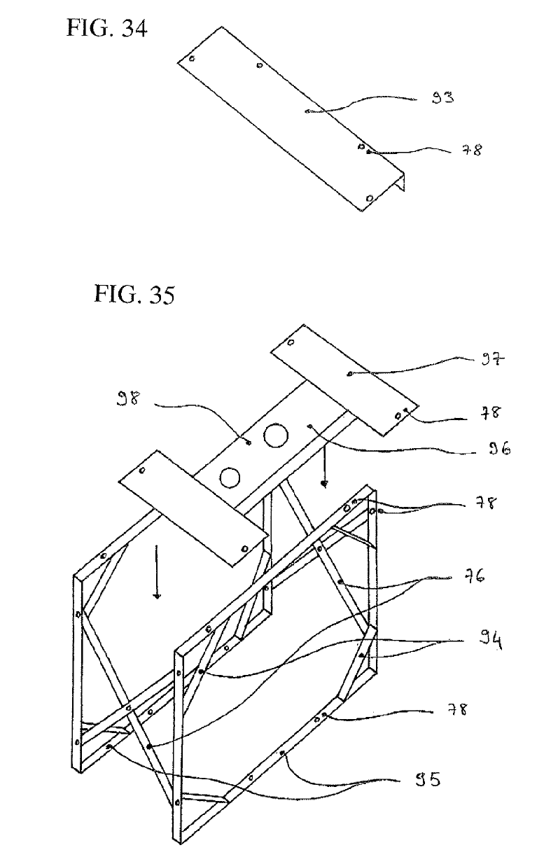

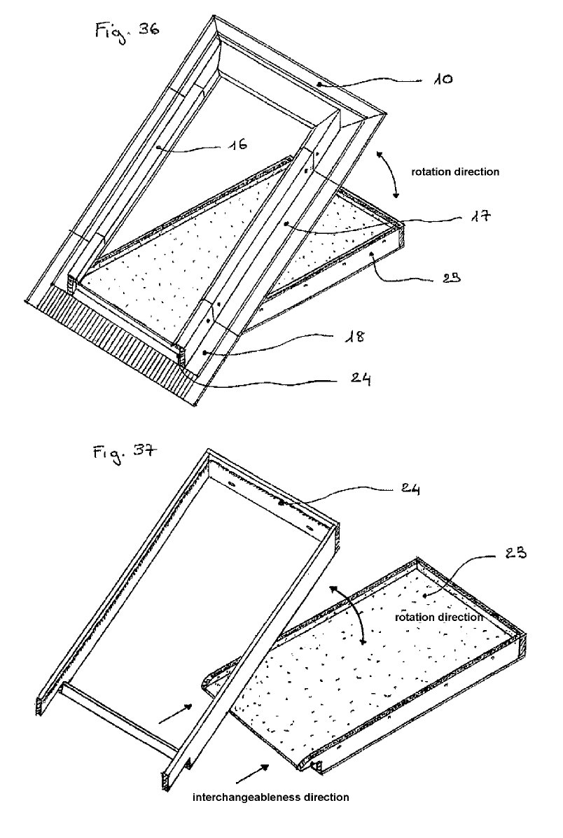

FIG. 35 is a general view of a flat support frame with braces for placing in a terrace roof or plate of the wind turbine; and

FIGS. 36 and 37 are overall perspective views of the support system of the invention, illustrating the direction of pivoting and the removability of the mobile panel relative to the fixed frame.

FIG. 1 has a roof support system according to the invention, made up of a mobile panel 23 comprising rims and receiving sealing and thermal insulation, which pivots in a fixed frame 24 fixed to the façade (for example a roof). The movement of the panel is illustrated in FIGS. 35 and 36.

The rims of the fitted and insulated mobile panel 23 and the fixed frame 24 are covered by roof connectors ensuring sealing, a low connector 18, a left lateral connector 17, a right lateral connector 16 and a top connector 10. This roof support system is conceived to be integrated into all types of cladding effecting covering of the roof, this cladding overlapping on the roof connectors.

FIGS. 2 to 5 detail the different roof connectors, generally made of metal, which enclose the fixed frame 24 of the roof support and comprise different parts ensuring sealing.

After fixing of the fixed frame 24 on the façade (for example a roof), the low roof connector 18 is first fixed on this fixed frame (24). This low connector comprises a first part, the skewback 14 forming planes fixed against the side of the fixed frame 24 by way of fixing holes. A second part is constituted by flats 11 formed by folding in an upper part of the skewbacks 14, which cover the top of the fixed frame 24 and the top of the rim of the mobile panel 23. A third part is constituted by planes 15 formed by folding of the flats 11, constituting water drops 15 which throw off rainwater inside the mobile panel 23.

A fourth part is formed by folding at the base of the skewbacks 14, and comprises a flat 13 which comprises a longitudinal boss in its central part, and a fold of the metal directed upwards on the lateral ends to prevent lateral flow of water towards the exterior of the low connector 18. A fifth part is constituted by a piece of metal 20 connecting the two lateral skewbacks 14, overlapping on a low part of the fixed frame 24, and comprising in its upper part a supple and compressible gasket 19 receiving the low part of the mobile panel 23. A sixth part is constituted by a piece 21 of supple metal serving to connect on the existing roof cladding, towards the base of the fixed frame (24).

The cladding of the roof overlaps on the sides of the low roof connector 18. Then, the lateral roof connector 16 and left roof connector 17 overlap to right and left on the low roof connector 18 and are fixed on the frame 24. These lateral roof connectors 16, 17 are composed of several parts serving to seal the assembly. As for the low connector 18, they each comprise a skewback 14 fixed on the side of the fixed frame 24, a covering flat 11 and a water drop 15. They also comprise a base flat 13 formed at the base of the skewbacks 14, comprising a longitudinal boss and a fold of the metal 12 at the end.

Then to finish, a top roof connector 10 overlaps at the top of the fixed frame 24, to right and left on the upper parts of the lateral right 16 and left 17 roof connectors, and is fixed on the fixed frame (24). The top roof connector 10 is composed of several parts ensuring tightness. As for the low connector 18, it comprises a skewback 14 fixed on the side of the fixed frame 24, a covering flat 11 and a water drop 15, a base flat formed at the base of the skewbacks 14, comprising a longitudinal boss and a fold of the metal 12 at the end.

FIG. 6 details the fixed frame 24 of the roof support system. This fixed frame 24 comprises two identical lateral sides 24A each having a notch 30 in the low part for letting through the connecting piece 20 of the low roof connector 18. It also comprises in the low part a lower side 24B of a height equivalent to the height of the connecting piece 20 of the low connector 18. It finally comprises in the upper part a side 24C of the same height as the lateral sides 24A.

The lateral sides 24A and the top side 24C take up on their inside flank and in the upper part a continuous supple seal 28 which prevents vibrations of this panel by gripping the rims of the mobile panel 23. The top side 24C has on the inside flank and in the lower part two notches 27 which receive latches of threshing type, fixed on the mobile panel 23 for blocking this panel in the fixed frame 24. Squares 26 serve to fix the fixed frame 24 onto the truss 25.

FIG. 7 shows a transversal section of the mobile panel with rims 23 and of the fixed frame 24. The mobile panel 23 comprises an upper plate 23A comprising sealing on the top which hoists on rims 40 framing the panels on at least three sides a lower plate 34 which serves as sub-face, thermal insulation 39 placed between the two plates to prevent a thermal bridge, and a continuous supple seal 33 placed on the top of the rims 40.

It is noted that the mobile panel 23 integrates inside the fixed frame 24, the rims 40 of the panel not rubbing against the sides 24A of the fixed frame 24 because of the supple seal 28. This figure shows also the fixing squares 26 connected on the one hand to the sides 24A of the fixed frame 24, and on the other hand to the façade 25 (for example a roof).

FIGS. 8 and 9 illustrate in a top and bottom plan view the mobile panel with rims 23 of the roof support system, composed of several elements serving on the one hand to ensure tightness of the assembly, and on the other hand permits pivoting in the fixed frame 24. The mobile panel 23 comprises rims 40 on the lateral sides and on the upper side, fixed to the plate by way of fixing bores 31. A seal covers the plate 23A and lifts on the flanks of the rims 40.

The plate 23A further comprises on its lower face and in its low part a transversal groove which passes right through the plate and the rims 40 to form a water drop 36 to prevent penetration of water by capillarity. The supple seal 33 set on the top of the rims 40 is compressed to ensure airtightness and watertightness, under the covering flats 11 of the different pieces of the low 18, lateral 16, 17, and top roof connector 10.

The low ends 37 of the lateral rims 40 are rounded to leave clearance in the vicinity of the low roof connector, enabling pivoting of the mobile panel 23 in the fixed frame 24 about a transversal axis located at the base of this mobile panel (23). The outer part 40A of the upper ridge of the rim of the top 40 is rounded to leave clearance of the panel outside the fixed frame 24 during pivoting.

The lower ends of the lateral rims 40 have in the low part a notch 35 for allowing passage of the connecting piece 20 of the low roof connector 18. A panel 34 closes the sub-face after placing of the insulation 39 which serves to prevent a thermal bridge.

The lower plate 34 receives in the upper part two latches of thresher type 38 to block pivoting of the mobile panel 23 in the fixed frame 24. A piece 40B connects the two right and left rims 40 in the low part, under the upper plate 23A, and receives on its outer face a supple seal 28 ensuring airtightness with the fixed frame 24.

Holding pieces, not shown, such as compass or cables, connect the sides of the mobile panel 23 to the fixed frame 24. They limit clearance of the panel during opening so as to ensure security and prevent it from falling, and keep it at an adequate height to allow an operator to intervene on the apparatus installed above.

FIGS. 10 to 20 present a roof support system according to the invention, equipped with the solar water heater. This roof support system comprises a sealed and insulated mobile panel with rims 23 pivoting in a fixed frame 24, low 18, lateral 16, 17, and top roof connectors 10.

Heat accumulator tubes 43 receive water circulation, or an accumulator liquid, or accumulator gas heated by solar radiation, and pass into rubber rings 42 which are set on high and central 44 metal platens, arranged transversally and equipped with semicylindrical metallic supports 53. The ends of the heat accumulator tubes 43 nest in rubber stoppers 45 which in turn nest in cylindrical metallic supports 46 fixed on the low metallic platen 47.

FIG. 11 has a feeder 41 turned by a quarter turn having orifices 49 receiving copper conduits of the heat accumulator tubes 43, and threaded copper tubes 48 for connecting the water inlet and discharge. This feeder 41 can be thermally insulated to prevent heat loss and ensure better yield.

FIG. 12 has the feeder 41 in its installation position.

FIG. 13 has a heat accumulator tube 43 fitted at one end with a copper conduit nesting in the orifices 49 of the feeder 41.

FIG. 14 has the high metallic platen 51 fitted with semicylindrical metallic supports 53 on which rest the heat accumulator tubes 43, by means of rubber rings 42. The top platen 51 also has borings 52 enabling fixing on the panel with rims 23, and borings 50 receiving the threaded copper tubes 48.

FIG. 15 has the central metallic platen 44 also fitted with semicylindrical metallic supports 53 and fixing holes 52.

FIG. 16 has the low metallic platen 47 comprising cylindrical metallic supports 46 receiving the ends of the heat accumulator tubes 43 fitted with rubber stoppers 45. It also has fixing borings 52 on the mobile panel with rims 23, and fixing borings 54 for the cylindrical metallic supports 46.

FIG. 17 has a rubber ring nesting on the heat accumulator tube 43 and resting on the semicylindrical support 53 of the top platen 51. FIG. 18 has the rubber ring resting on the semicylindrical support 53 of the central platen 44.

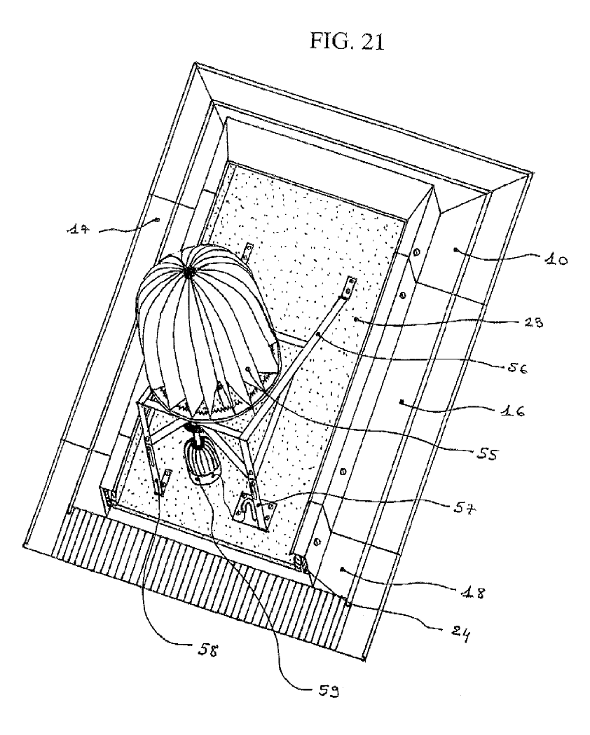

FIG. 19 has an end rubber stopper 45 of the heat accumulator tube 43.

FIG. 20 has a cylindrical metallic support 46 fixed on the low metallic platen 47 which receives the end rubber stopper 45 of the heat accumulator tube 43.

The feeder 41 can comprise an automatic or manual draining valve for eliminating air from the water circuit. It can be connected on the water circuit, or to the electric hot-water balloon, by lagged pipes. The outlets can be equipped with a stopcock with draining valve arranged in the vicinity of the mobile panel (23), for emptying water from the feeder before disconnecting it, to allow pivoting or dismantling of the mobile panel (23).

As a variant, water from the circuit is heated to above boiling temperature to produce steam which actuates a turbine connected to an electricity generator, a heat exchanger or pump producing cold or heat for air-conditioning.

FIG. 21 schematically shows a roof support system equipped with a wind turbine, made according to the invention. This roof support system is composed of a mobile panel element with rims 23 pivoting in a fixed frame 24. The rims of the mobile panel 23 and the fixed frame 24 receive roof connectors 10, 16, 17, and 18 in the same way, to ensure tightness.

A wind turbine with blades 55 is fixed on a metallic frame support 56, itself fixed with or without chassis-mounting rubber on the mobile panel with rims 23. The metallic frame 56 is fixed in the upper part on the mobile panel with rims 23 by hinges, and in the low part by squares also containing hinges. The metallic frame support 56 receives the generator or alternator motor 59. Also, the mobile panel 23 or the fixed frame 24 comprises a passage for a connecting cable of the wind turbine.

FIGS. 22 to 25 present the blade turret 55 of the wind turbine with vertical axis, comprising metal blades 55A which extend vertically from top to bottom in describing a curve, a large wheel 60 comprising internal teeth which constitutes the base of the blade turret 55, the outer diameter of this wheel being adjusted to that of the blades, a small toothed wheel 63 fixed on the arbour of a generator or alternator motor 65, which is driven by the internal teeth of the large wheel. The arbour 61 of the blade turret 55 and also the arbour 64 of the motor are each equipped with two ball bearings 62 fixed to the metallic frame support 56.

FIG. 23 has the blade turret 55 arranged horizontally.

FIG. 24 has this turret viewed from underneath.

FIGS. 26 to 28 present the support 56 in detail. It comprises a metallic frame reinforced by bracing 73 arranged on the sides. Towards the base of the slope, a descending part 79 is reinforced by bracing 73, and is fixed to a large side 67 of the two squares 57, 58, fitted with an oblong hole 66 for adjusting the level of the support 56. This square 57, 58 comprises a connecting hinge 69 with a side 68 equipped with fixing holes 75 for fixing, with or without chassis-mounting rubber, to the mobile panel with rims 23, the hinge allowing adjusting relative to the slope of the panel. Also, for one of the squares, the side 68 set on the roof of the square 57 is wider and comprises a bracket 74 for passage of an electric cable.

The metallic frame has at its centre superposed metallic platens 71, 72 for fixing ball bearings 62 of the generator or alternator motor 65, and those of the blade turret 55. The metallic frame comprises two hinges in the upper part comprising fixing holes 75, which serve as fixing, with or without chassis-mounting rubber, on the panels mobile with rims 23. These hinges also regulate relative to the slope of the mobile panel (23).

The alternator motor or generator 65 can comprise a clutch which is engaged when wind force is sufficient. It can be connected by electric cable to an inverter to supply continuous current of the same voltage without distortion. A battery can serve to store current produced by the alternator or the generator 65 after the inverter.

The support metallic frame 56 can comprise cladding on its façade and its sides to integrate aesthetically in the landscape.

The colours of the blades of the turret can be black on one side to absorb heat, and white or reflecting on the other to send back heat to create a hot and cold air current differential for powering the blade turret to improve performance.

FIG. 29 schematically shows a roof support system equipped with a support metallic 80 for terrace or plate roof. This metallic support 80 receiving the sealed panel with rims 23B is composed of two frames 77 with bracing made in metallic flats 76 fixed by fixing holes 78, a spacer flat 79 also fixed by fixing holes 78 connecting the two frames.

FIG. 30 has a frame 77 with bracing 81, 82 in the low part. The upper part of the low side 83 protrudes from an inclined bar 92 on which rests the panel with rims 23 to form a stop for supporting this panel. Fixing holes 68 serve to fix with or without chassis-mounting rubber, the frame to the ground and to the panel with rims 23.

FIG. 31 has a roof support system equipped with a photovoltaic solar cell, made according to the invention. This roof support system is composed of a mobile panel element with rims 23 pivoting in a fixed frame 24. The rims of the mobile panel 23 and the fixed frame 24 similarly receive roof connectors 10, 16, 17, and 18, to ensure tightness.

FIG. 32 details a metallic frame support 90 receiving the solar photovoltaic elements 89 composing the complete photovoltaic solar cell 84. On its long sides, this metallic frame support 90 comprises metallic channel sections 85 interconnected by metallic flats 86 fitted with fixing holes 87 for fixing solar photovoltaic elements 89 arranged beside one another, to constitute the complete photovoltaic solar cell 84. The metallic channel sections 85 are fixed by fixing holes 91 on the mobile panel with rims 23 of the roof support system.

FIG. 33 details just one solar photovoltaic element 89, after side-by-side assembly of the others on the metallic frame support 90, these elements making up the complete photovoltaic solar cell 84.

The photovoltaic solar cell is connected by an electric cable to an inverter to supply a continuous current of the same voltage without distortion. After the inverter, one or more storage batteries of the current produced to regularize supplying electricity over time can be put in place.

By way of advantage, the mobile panel 23 or the fixed frame 24 comprises a passage for a connecting cable from the wind turbine or solar cells. Also, a rapid connector mounted on the cable and located inside the building in the vicinity of the fixed frame 24 facilitates maintenance operations for opening the mobile panel 23 and optionally lodge it or disassembling the apparatus.

FIG. 34 details a metallic channel section 93 which can cover the top of a sealed panel with rims 23B set on a metallic support 80 for terrace or plate roof to protect apparatus set on the top of the panel.

FIG. 35 details a metallic frame support for fitting on a terrace or plate roof of the wind turbine presented hereinabove. This metallic frame support is composed of two sides 95 connected by bracing 76 forming crosses, each side being reinforced by bracing 94. Borings 78 on the sides 95 serve to fix the different bracing 76, 94, the metallic platen receiving the blade turret 55 and the generator or alternator motor 65, and fix the assembly to the ground.

This support for fitting on a terrace or plate roof is fixed on a removable panel, also comprising sealing devices. This removable panel can be opened towards the bottom from the inside of the building to attend to equipment placed above.

In general, roof support systems presented hereinabove and equipped with different energy recovery devices can be integrated into all types of roof cladding, which overlaps the roof connectors.

After the fixing latches are unlocked, they allow opening of the mobile panel support with rims 23 by rocking its upper end downwards and to the inside, its lower part remaining supported by the roof. Devices for holding in open position keep this panel at a certain height, for example near the horizontal position, to allow a person to attend to the energy recovery device located above. The mobile panel 23 can also be fully lodged to allow it to be fitted or replaced easily, if needed.

Interventions such as installation, periodic maintenance or repairs are easy to carry out. Each type of apparatus can be easily sustained by a non-qualified person, not having to climb on the roof, to carry out for example regular cleaning of the solar water-heating tubes or photovoltaic cells, or control of the free rotation of the wind turbine so that these devices may retain all their energy recovery capacities.

1. A mobile support system for energy recovery device, wherein said system comprises a fixed frame (24), intended to be integrated in a building façade, and a mobile panel (23) supporting on its upper face the energy recovery device, this mobile panel (23) opening from top to bottom and towards the inside of the building by pivoting on an axis supported on the fixed frame (24) to allow full access to the energy recovery device via the inside of the building.

2. The support system as claimed in claim 1, wherein the mobile panel (23) comprises rims (40) which protrude upwards on at least three sides, these three sides being elevated in the case of a sloping roof.

3. The support system as claimed in claim 2, wherein the mobile panel (23) comprises sealing on the top which is hoisted on the rims (40) to form protection against rainwater.

4. The support system as claimed in claim 1, wherein the mobile panel (23) pivots on an axis supported on the transversal bar (24B) of the fixed frame (24), and opens completely from the top to the bottom, and towards the inside of the building to allow full access to the energy recovery device via the inside of the building.

5. The support system as claimed in claim 1, wherein the mobile panel (23) is completely removable towards the inside of the building.

6. The support system as claimed in claim 1, intended to be integrated in an inclined roof, wherein the fixed frame (24) contains in its low part a bar (24B) arranged transversally relative to the slope of the roof, the low part of the lateral rims (40) of the mobile frame (23) having lower notches forming clearance allowing the mobile panel to be supported on this transversal bar (24B) which forms a pivot axis, and/or angles (37) on the top cut or rounded to allow clearance with the low roof connector (18).

7. The support system as claimed in claim 2, wherein roof connectors (10, 16, 17, 18) on the one hand cover the fixed frame (24) and the rims of the mobile panel (23), and on the other hand glide in part under the cladding of the roof to form protection of the rims of the mobile panel (23) and of the fixed frame (24) against rainwater.

8. The support system as claimed in claim 7, wherein a supple seal (33) is arranged between the upper parts of the rims (40) and the lower faces of the roof connectors (10, 16, 17, 18) to be compressed and thus ensure watertightness and airtightness.

9. The support system as claimed in claim 1, wherein the support has holding means of compass or cable type, fixed on the one hand to the fixed frame (24) and on the other hand to the mobile panel (23), which keeps the mobile panel in a predefined position after opening.

10. The support system as claimed in claim 2, wherein the mobile panel (23) is locked in the fixed frame (24) in closed position by means attached on the one hand to the mobile panel (23) and on the other hand to the fixed frame (24).

11. The support system as claimed in claim 2, wherein a supple gasket (28) is placed between the fixed frame (24) and the rims of the mobile panel (23) to ensure airtightness.

12. The support system as claimed in claim 1, wherein the mobile panel (23) comprises two spaced plates (23A, 34), and in that thermal insulation (39) is placed between these plates to prevent a thermal bridge.

13. The support system as claimed in claim 1, wherein the mobile panel (23) has on its upper face a support (44, 51, 56, 90) receiving the energy recovery device.

14. The support system as claimed in claim 13, wherein the support (56) receives the wind turbine, and in that the mobile panel (23) or the fixed frame (24) comprising a passage for a connecting cable of the wind turbine.

15. The support system as claimed in claim 14, wherein the support has feet (57, 58) which adapt to the slope of the roof, comprising hinges (69) for example.

16. The support system as claimed in claim 14, wherein the support (56) comprises fittings for holding bearings (62) supporting on the one hand the axis of the rotor of the wind turbine (61), and on the other hand the axis (64) of a generator (65).

17. The support system as claimed in claim 14, wherein the rotor of the wind turbine is composed of blades fixed about the axis (61) and rounded in the upper part for the opening clearance of the mobile panel (23).

18. The support system as claimed in claim 14, wherein the rotor of the wind turbine comprises in its low part a wheel (60) with internal teeth, arranged perpendicularly to the axis of rotation, and in that a toothed pinion (63) fixed on the axis (64) of the generator (65) meshes with this wheel.

19. The support system as claimed in claim 13, wherein the support (56) receives a photovoltaic solar cell (84), the mobile panel (23) or the fixed frame (24) comprising a passage for a connecting cable of these solar cells.

20. The support system as claimed in claim 14, wherein the connecting cable comprises a rapid connector located inside the building, in the vicinity of the fixed frame (24).

21. The support system as claimed in claim 13, wherein the support (44, 51) receives water circulation tubes (43), or accumulator liquid, or accumulator gas heated by solar radiation.

22. The support system as claimed in claim 21, wherein the tubes (43) are set by means of supple pieces (42) on supports comprising platens (44, 51) arranged transversally on the mobile panel (23), and in that the ends of the tubes located on the same side are connected to a feeder (41) fixed on the upper part of the mobile panel (23), and in that the tubes are blocked at the ends in the low part by pieces (46).

23. The support system as claimed in claim 22, wherein the feeder (41) is connected inside the building and in the vicinity of the fixed frame (24) by connectors comprising stopcocks fitted with a draining valve for evacuating water and thus carrying out dismantling and pivoting of the mobile panel (23).

24. An installation process of an energy recovery device on a building, the process comprising the integration of the device in a support system comprising a fixed frame (24) fixed on the façade of the building and a mobile panel (23) supporting on its upper face the energy recovery device, this mobile panel (23) opening from the top to the bottom and towards the inside of the building by pivoting on an axis supported on the fixed frame (24), allowing access to the energy recovery device via the inside of the building.

25. A wind turbine, wherein said turbine comprises a set of curved blades extending vertically from the top to the base of a turret, in multiple directions, and an energy accumulator device, in that the wind turbine is mounted on a toothed wheel whereof the axis of rotation is out of alignment relative to that of the accumulator device, and in that the accumulator device is driven by a toothed wheel of a diameter less than that of the toothed wheel bearing the turret, resulting in a multiplication effect.

26. The wind turbine as claimed in claim 25, wherein said turbine comprises a set of curved blades, each having a face of dark colour and another face of light colour, to produce a current differential of hot air and cold air to improve energetic performance.

27. A solar water heater, wherein said heater comprises a turbine connected to an electric generator actuated by the water vapour produced by the water circulation tubes (43), or accumulator liquid, or accumulator gas heated by the solar radiation to produce energy.

28. The solar water heater of claim 27, wherein said heater comprises a heat exchanger or pump for producing cold or heat to create air-conditioning.
